(19) United States
(12) Patent Application Publication
(10) Pub. No.: US 2019/0173096 A1
(43) Pub. Date: Jun. 6, 2019

(54) Intermediate-Temperature Fuel Cell Tailored for Efficient Utilization of Methane

(71) Applicants: Georgia Tech Research Corporation, Atlanta, GA (US); University of Kansas, Lawrence, KS (US)

(72) Inventors: Meilin Liu, Atlanta, GA (US); Ik Whang Chang, Atlanta, GA (US); Yu Chen, Atlanta, GA (US); Ben M. Deglee, Atlanta, GA (US); Brian Doyle, Atlanta, GA (US); Franklin Tao, Lawrence, KS (US); Lei Zhang, Atlanta, GA (US)

(21) Appl. No.: 16/318,246

(22) PCT Filed: Jul. 19, 2017
(86) PCT No.: PCT/US17/42829

§ 371 Date: Jan. 16, 2019

Related U.S. Application Data
(60) Provisional application No. 62/364,102, filed on Jul. 19, 2016.

(51) Int. Cl. H01M 4/86; H01M 4/90; H01M 8/0637; H01M 8/1253; H01M 8/126

(52) U.S. Cl. CPC H01M 4/8657; H01M 4/9033; H01M 2008/1293; H01M 8/1253; H01M 8/126; H01M 8/0637

(57) ABSTRACT

A solid oxide fuel cell capable of directly utilizing hydrocarbons as a fuel source at operating temperatures between 200° C. and 500° C. The anode, electrolyte, and cathode of the solid oxide fuel cell can include technologies for improved operation at temperatures between 200° C. and 500° C. The anode can include technologies for improved direct utilization of hydrocarbon fuel sources.

### BACKGROUND

### 1. Field of the Invention

The present invention relates generally to solid oxide fuel cells, and more particularly to materials and structures utilized to improve intermediate temperature (˜200° C. to ˜500° C.) operation of the anode, electrolyte, and cathode layers of solid oxide fuel cells fueled directly by a hydrocarbon fuel source.

### 2. Description of Related Art

The demand for clean, secure, and economically competitive energy has stimulated interest in fuel cells for efficient energy conversion. Among all types of fuel cells, solid oxide fuel cells (SOFCs) are the cleanest, most efficient chemical-to-electrical energy conversion systems with excellent fuel flexibility. However, broad commercialization of SOFC technology remains hampered by relatively high cost and limited system lifetime.

SOFCs are currently cost prohibitive because of the high temperatures (1000° C.) required to achieve efficient, long term operation. Reducing the operating temperatures of the current SOFC systems to between ˜200° C. to ˜500° C. could dramatically reduce the cost of the SOFC technology since relatively inexpensive metallic components could be used for interconnects, heat exchangers, manifolding, and other structural components of the SOFC system.

Lowering the operation temperature can also offer quick start-up ability, which in turn can enable their use in applications such as transportable power sources and auxiliary power units for automobiles.

A lower operating temperature would also ensure a greater overall system stability and durability due to a reduction in the thermal stresses in the active ceramic structures, leading to a longer expected lifetime for the SOFC system.

Unfortunately, lowering the operating temperature decreases performance at each of the three main components of the SOFC: the anode, the electrolyte, and the cathode.

SOFCs can be fueled by hydrogen or hydrocarbons. Hydrogen that is used to fuel SOFCs can be generated by an external hydrocarbon reforming system, resulting in a loss of fuel value during this process. Eliminating the external hydrocarbon reforming system that generates hydrogen and directly utilizing hydrocarbon fuels could increase SOFC efficiency while decreasing the complexity and cost of the SOFC system. However, technological challenges still remain in creating an SOFC capable of utilizing hydrocarbons, particularly at intermediate temperatures.

For reference, the functionality and cross section of a single, basic SOFC representative of technology in related art is illustrated in FIG. 1. Single SOFCs are typically connected together electrically in series or parallel to form an SOFC stack.

The anode in related art SOFCs typically serves to oxidize fuel using oxygen ions that have transported through the electrolyte, conduct electrons to the load following the oxidation reaction, and provide structural support for the fuel cell. The anode of an SOFC is typically porous (allowing the flow of fuel to the electrode), conductive (to transport electrons), and includes an oxygen-conducting phase (such as ceria oxide).

SOFC fuel cells fueled by hydrogen can utilize for example nickel yttria-stabilized zirconia (Ni-YSZ) cermets as an inexpensive, stable anode material. Unfortunately, such Ni-based anodes deactivate rapidly with direct utilization of hydrocarbon fuels to due carbon deposition on the Ni catalyst surface, and are therefore not a viable anode material for an SOFC fueled directly by hydrocarbons. Related art SOFCs directly utilizing hydrocarbon fuel can utilize catalysts in the anode to promote reforming reactions, thereby reducing carbon deposition in the anode; however reforming reactions are not favored at intermediate temperatures.

The electrolyte used in related art SOFCs is typically composed of a dense layer of ceramic that conducts oxygen ions but has low electron conductivity. Popular electrolyte materials include yttria-stabilized zirconia (YSZ), Scandia stabilized zirconia (ScSZ), and gadolinium doped ceria (GDC). However, at operating temperatures below 600° C., the electrolyte develops increased resistance to ionic transport, thereby affecting the overall performance of the fuel cell. Consequently, GDC or sameria-doped ceria (SDC) that has a higher conductivity of ions have been used as the electrolyte for operation in the intermediate temperature range; however, these materials can also allow electrons to traverse the electrolyte, resulting in unwanted leakage current and thereby hampering SOFC device performance.

The cathode in related art SOFCs is typically a thin, porous, electrically conductive layer deposited on the electrolyte that serves to conduct electrons to the incoming oxygen and reduce the oxygen. Because the oxygen reduction reaction requires greater energy at lower temperatures, typical cathode materials become unable to efficiently reduce oxygen at lower temperatures, thereby affecting the overall performance of the fuel cell.

In view of the above, a need exists for improved technologies in the anode, electrode, and cathode layers of SOFCs in order to develop a high performance intermediate temperature direct-hydrocarbon SOFC.

It is thus an intention of the present invention to implement inventive technologies improving the anode, electrolyte, and cathode that improves performance at intermediate temperatures (as used herein, 200° C. to ˜500° C.) using methane, which is a more energy dense and less energy-intensive fuel as compared to hydrogen, and already has a large installed infrastructure to draw upon. As the anode does the methane processing, another aspect of the present invention is to improve it for both hydrocarbon processing and low temperature. The electrolyte and cathode layer technologies are re-imagined to address the lower temperature challenges.

### SUMMARY

Briefly described, in an exemplary form, the present invention is an innovative approach to the fuel cell, wherein improved technologies are incorporated into the anode, electrolyte, and cathode to provide optimal performance at intermediate temperatures using methane.

On the anode, an optimized doped ceria catalyst has been developed that is active for wet and dry reforming of methane below approximately 500° C. The anode has coking stability of the catalyst after 200+ hours of testing in 97% methane with 3% water. It can operate on such a low water content by optimizing the phases on the surface of the anode. For example, the fuel cell of the present invention can operate at 200 mA/cm² at 0.75 V without deactivation.

For the electrolyte, a synergistic effect was found when two different ionic conductors are processed to increase the number of interfaces. Increasing the density of these interfaces increases the ionic conductivity to a value greater than either individual component. Additionally, an increase in ionic conductivity for nanostructured electrolytes was observed that can further enhance overall cell performance.

On the cathode, a high performance transition metal oxide catalyst was produced using a scalable electrospinning fiber technique. The dual ionic and electronic conductivity of the material, combined with the high surface area of a hollow nanofiber architecture, allows for increased catalytic activity toward the oxygen reduction reaction.

In another exemplary embodiment, the present invention is a next generation fuel cell with a high oxygen reduction reaction (ORR) kinetic cathode, a highly efficient catalytic active layered anode enabling methane reforming, and direct operation on methane at approximately 500° C. Highly active cathode nanofibers coated with nanoparticles can efficiently enhance ORR kinetics. The rational design of a layered anode comprising a reforming catalyst layer, a modified support layer, and an anode functional layer, shows high coking tolerant and methane reformation rate. A single exemplary cell can yield a peak power density of 0.368 W/cm² at 500° C., and has a long durability of 200 hours, when wet methane (for example, 3 vol % steam) was directly used as fuel and ambient air as oxidant.

In another exemplary embodiment, the present invention is a intermediate-temperature fuel cell comprising an anode comprising a doped ceria catalyst, an electrolyte, and a cathode, wherein the fuel cell is configured to directly utilize hydrocarbon fuel at temperatures of 500° C. or less.

The anode can comprises an anode functional layer (AFL), an anode support layer (ASL), and an anode reforming layer (ARL).

The AFL and ASL layers can comprise Ni-based material. The AFL and ASL layers can comprise Ni—BaZr_{0.1}Ce_{0.7}Y_{0.1}Yb_{0.1}O_{3-δ}.

The ARL layer can comprises the doped ceria catalyst.

The ASL layer can be impregnated with sameria-doped ceria (SDC).

The AFL and ASL layers can a pore structure, wherein the AFL layer has a finer pore structure than the ASL layer.

The doped ceria catalyst can comprise Ni and Ru doped ceria. The doped ceria catalyst can comprises Ni and Ru supported ceria. The doped ceria catalyst can comprises Ni and Ru doped ceria and Ni and Ru supported ceria.

At least a portion of the dopants can be ions dispersed on a surface of the ceria.

The doped ceria comprises nanofibers.

The sum of Ni and Ru by weight can be approximately 10% or less. The Ni can present at approximately 5% by weight of the ARL. The Ru can be present at approximately 5% by weight of the ARL.

The doped ceria can include an oxygen vacancy near one of the Ni or Ru dopants dispersed as ions on the surface of the ceria. The oxygen vacancy can play an active role in a methane reforming reaction.

The electrolyte can comprises an oxygen ion transporting solid oxide fuel cell (SOFC) electrolyte material, and a proton transporting SOFC electrolyte material. The oxygen ion transporting SOFC electrolyte material can comprise sameria-doped ceria. The proton transporting SOFC electrolyte material can comprises barium yttrium zirconate.

The ratio of oxygen ion transporting SOFC electrolyte material to proton transporting SOFC electrolyte material can be approximately 1:10.

The electrolyte can comprise alternating layers of the oxygen ion transporting SOFC electrolyte material and the proton transporting SOFC electrolyte material.

Grain boundaries between the oxygen ion transporting SOFC electrolyte material and the proton transporting SOFC electrolyte material can be substantially vertical.

The cathode comprises hollow oxide nanofibers. The nanofibers can have an average outer diameter between 200 nm and 400 nm and an average inner diameter between 50 nm and 150 nm.

The nanofibers can comprise one or more materials selected from the group consisting of PrBa_{0.5}Sr_{0.5}Co_{1.5}Fe_{0.5}O_{5+δ}, La_{0.6}Sr_{0.4}Co_{0.2}Fe_{0.8}O₃, PrBa_{0.5}Sr_{0.5}Co₂O₆, and Sm_{0.5}Sr_{0.5}CoO₃.

Nanoparticles can reside on an outer surface of the hollow oxide nanofibers.

The nanoparticles can comprise one or more materials selected from the group consisting of PrOₓ, sameria-doped ceria (SDC), gadolinia-doped ceria (GDC), and Pr_{0.1}Ce_{0.9}O₂, Pr₂Ni_{0.5}Mn_{0.5}O₄.

The cathode can be formed by the process of electrospinning an oxide material, calcining the electrospun oxide material, resulting in a mat of hollow oxide nanofibers, flooding the mat of hollow oxide nanofibers with a mixture containing a binder and a solvent, drying the mat of hollow oxide nanofibers, and bonding the mat of hollow oxide nanofibers to an electrolyte layer.

The fuel cell of any exemplary embodiment of the present invention can be configured to directly utilize hydrocarbon fuel while operating with a current density of at least 200 mA/cm² and an open circuit voltage of 0.75 V at temperatures of 500° C. or less for two hours or more without deactivation.

The fuel cell of any exemplary embodiment of the present invention can be configured to directly utilize hydrocarbon fuel and yield a peak power density of 0.368 W/cm² at temperatures of 500° C. or less.

In another exemplary embodiment, the present invention is a intermediate-temperature fuel cell comprising an anode comprising an anode functional layer (AFL), an anode support layer (ASL), and an anode reforming layer (ARL) comprising a doped ceria catalyst selected from the group consisting of Ni and Ru doped ceria, Ni and Ru supported ceria, and both of Ni and Ru doped ceria and Ni and Ru supported ceria, a composite material electrolyte comprising an oxygen ion transporting solid oxide fuel cell (SOFC) electrolyte material, and a proton transporting SOFC electrolyte material, and a cathode comprising hollow oxide nanofibers, wherein the fuel cell is configured to directly utilize hydrocarbon fuel at temperatures of 500° C. or less.

In another exemplary embodiment, the present invention is a intermediate-temperature fuel cell comprising an anode comprising a doped ceria catalyst that is active for wet and dry reforming of methane below approximately 500° C., a composite material electrolyte comprising an oxygen ion transporting SOFC electrolyte material, and a proton transporting SOFC electrolyte material, and a cathode comprising a hollow nanofiber architecture.

In another exemplary embodiment, the present invention is a solid oxide fuel cell (SOFC) comprising an anode comprising an anode functional layer (AFL), an anode support layer (ASL), and anode reforming layer (ARL), and an electrolyte layer, wherein an electron blocking layer is formed between the AFL and electrolyte layer.

In another exemplary embodiment, the present invention is an anode for a solid oxide fuel cell (SOFC) comprising a doped ceria catalyst that is active for wet and dry reforming of methane below approximately 500° C.

In another exemplary embodiment, the present invention is an electrolyte for an SOFC comprising an oxygen ion transporting SOFC electrolyte material, and a proton transporting SOFC electrolyte material.

In another exemplary embodiment, the present invention is a cathode for an SOFC comprising a hollow nanofiber architecture.

In another exemplary embodiment, the present invention is a method of forming an SOFC comprising forming an anode support layer (ASL), forming an anode functional layer (AFL) on a top of the ASL, forming an electrode layer on a top of the AFL layer, co-firing the ASL, AFL, and electrode layers, forming a cathode layer on a top of the electrode layer, co-firing the ASL, AFL, electrode, and cathode layers, forming an anode reforming layer (ARL) on a bottom of the ASL, and co-firing the ASL, AFL, electrode, cathode, and ARL layers.

The method can further comprise contacting a buffer layer material with a top of the electrode layer, and/or impregnating the ASL layer with Sm_{0.52}CeO_{1.9}.

### BRIEF DESCRIPTION OF THE DRAWINGS

FIG. 1 illustrates the layers and operation of a single SOFC according to prior art.

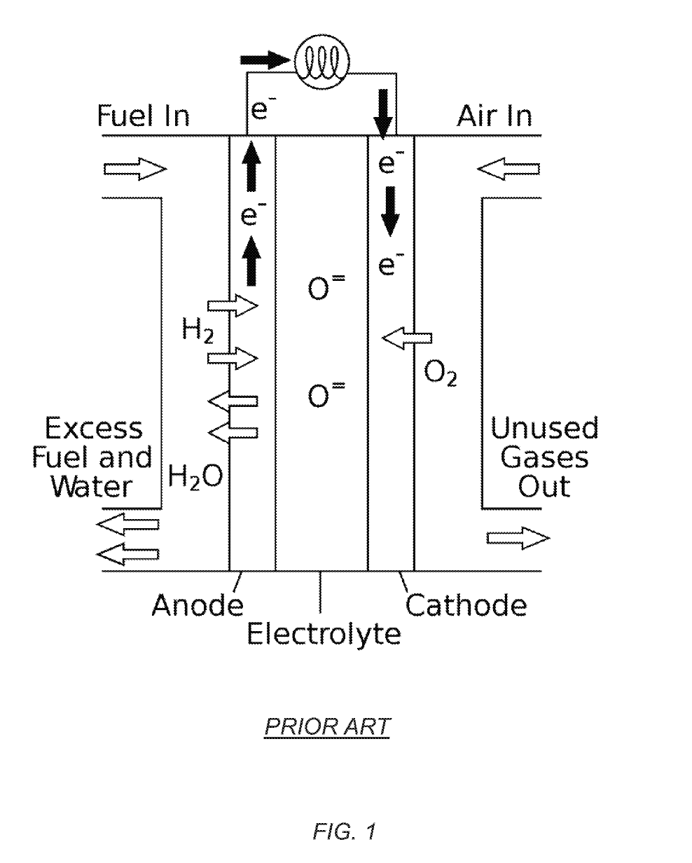

FIG. 2 illustrates certain technologies described in the present disclosure according to some example embodiments.

FIGS. 3(a1), 3(b1), 3(a2), 3(b2), 3(a3), and 3(b3) show catalytic performance data of catalysts having varying ratios of ruthenium (Ru) and nickel (Ni) dopants, as a function of temperature.

FIG. 4 shows a conceptual drawing illustrating ion transport in a mixed-ion conducting membrane electrolyte structure including an oxide ion conductor and a proton conductor according to an example embodiment.

FIG. 5 shows ion conductivity as a function of temperature for mixed-ion conducting membrane electrolyte structures having various heterostructures according to an example embodiment.

FIGS. 6(a), 6(b), 6(c), and 6(d) show cross-sectional images of an example fabricated SOFC showing certain layers of the SOFC structure at increasing magnification according to an example embodiment.

FIGS. 7(a) and 7(b) show electrical testing data from hollow nanofiber cathode structures according to an example embodiment compared to nano powder cathode structures.

FIG. 8 shows data from an example functional SOFC incorporating certain technologies described herein according to an example embodiment.

### DETAILED DESCRIPTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Examples of an SOFC capable of converting hydrocarbon fuels at temperatures in an intermediate (200° C. to 500° C.) range are presented. Technologies for improving the operation of the anode, electrode, and cathode fuel cell components are presented. As will be appreciated and understood, improvements described herein can be used together, separately, or combined with other technologies.

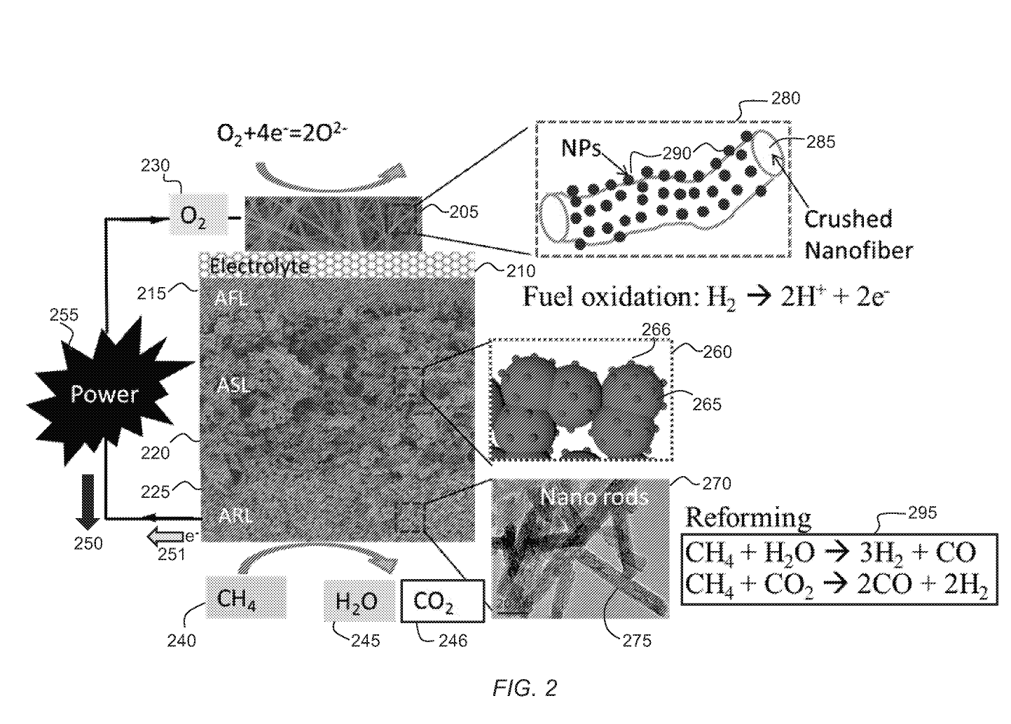

An example SOFC utilizing technologies according to some embodiments is illustrated in FIG. 2. As shown in FIG. 2, an SOFC according to some embodiments can include a three layer anode 225, 220, 215, an electrolyte layer 210, and a cathode layer 205.

Referring to layered structures, such as FIG. 2, a side of a layer that is vertically up as depicted in FIG. 2 will be referred to herein as a “top side”, and a side of a layer that is vertically down as depicted in FIG. 2 will be referred to herein as a “bottom side”. For example, in FIG. 2, a bottom side of an anode reforming layer (ARL) 225 can be exposed to fuel; a top side of the ARL 225 can interface with a bottom side of an anode support layer (ASL) 220; a top side of the ASL 220 can interface with a bottom side of an anode functional layer (AFL) 215; the top side of an AFL 215 can interface with a bottom side of an electrolyte layer 210; a top side of the electrolyte layer 210 can interface with a bottom side of a cathode layer 205; and a top side of a cathode layer 205 can be exposed to oxygen or an oxygen-air mixture 230.

Each layer can include technologies to improve the functionality of that layer, the functionality of the interfaces between layers, and the functionality of the SOFC as a whole. As will be appreciated and understood, certain technologies disclosed herein can be incorporated individually, combined with other technologies, or together to create an improved SOFC. The example SOFC illustrated in FIG. 2 is therefore not intended to limit the scope of the present disclosure, as certain technologies described herein can be utilized with other structures including other SOFC structures or non-SOFC structures.

Each layer is described starting with the bottom, ARL layer and ending with the top, cathode layer. As will be appreciated and understood, the order in which the layers are described does not imply any particular SOFC fabrication order or techniques unless specifically stated herein; nor is the order in which the layers is discussed intended the limit the functionality of the SOFC or the possible applications of the technologies described herein.

Anode Technologies

As shown in FIG. 2, according to some embodiments, the anode can comprise three layers: ARL 225, ASL 220, and AFL 215. Each of the three layers can serve to improve the overall functionality of the anode and the therefore the functionality of the SOFC. As will be appreciated and understood, certain technologies incorporated into the anode layers can be used individually, combined with other technologies, or used together to create an improved anode structure.

The ARL 225 can have a bottom side configured to be in contact with a hydrogen or hydrocarbon fuel source 240. The ARL can be composed of porous material including a reforming catalyst that is resistant to carbon deposition, promotes the disassociation of hydrogen from carbon and atoms in hydrocarbon molecules, and promotes the oxidation of carbon atoms. The reforming catalyst can comprise Ce_{0.9}Ni_{0.05}Ru_{0.05}O_{2-δ} (CNR). The bottom side of the ARL can allow hydrocarbon fuel 240, such as methane, to enter the ARL 225, and the bottom side of the ARL 225 can allow water 245 and carbon dioxide 246 to exit the ARL 225.

Carbon reforming reactions 295 can occur in the ARL 225. Carbon reforming reactions 295 can limit or eliminate carbon deposition in the anode when hydrocarbons are directly used as a fuel source for the SOFC. The carbon reforming reactions 295 can be facilitated by catalysts within the ARL 225. The catalysts can be in the form of singly ionized dopants or nanoparticles.

Hydrogen and carbon monoxide can exit the ARL 225 and enter the ASL 220 through the interface between the ARL 225 and ASL 220. Oxygen, water, and carbon dioxide can enter the ARL through the interface between the ARL and ASL. The ARL can be electrically conductive and can be connected to an electrical contact that can be configured to allow the flow of electrons 251 from the ARL 225 to an external electrical load 255.

The ARL can be composed of nickel (Ni) and ruthenium (Ru) doped ceria or other oxygen-transporting electrolyte. At least some of the Ni and Ru dopants can be ions that are dispersed on the surface of the ceria. The percentage of dopants by weight to the total weight of the doped ceria can be less than 10%.

FIG. 2 shows a magnified image 270 of ARL 225 material according to some embodiments. As shown in FIG. 2, the ARL 225 can be composed of nanofibers or nanorods 275. According to some embodiments, the nanorods 275 can be ceria nanorods having Ni and Ru dopants, where at least some of the dopants are singly dispersed ions on the surface of the nanorods 275. The nanorods may further include oxygen vacancies at sites near the singly dispersed Ni and Ru ions, and these oxygen vacancies may play an active role in the methane reforming process.

The ASL 220 can provide mechanical support for the SOFC structure, can be highly porous to allow for the flow of gas, and can include catalysts for promoting oxidation of carbon monoxide and hydrogen. The ASL 220 can be created through typecasting, or other known process

FIG. 2 shows a magnified drawing 260 of the porous material 265 of the ASL 220 with nanoparticles 266 on the surface of the porous material 265. The porous material 265 can be Ni—BaZr_{0.1}Ce_{0.7}Y_{0.1}Yb_{0.1}O_{3-δ} (Ni-BZCYYb), other nickel based material, or other suitable material. The porous material 265 can be impregnated with samaria-doped ceria (SDC), for example Sm_{0.52}CeO_{1.9}, or other coking tolerant material. As shown in FIG. 2, SDC can reside on the surface of the porous material 265 as nanoparticles 266.

The ASL 220 can transport ionized oxygen from the interface with the AFL 215 at the top side of the ASL 220 to the interface with the ARL 225 at the bottom side of the ASL 220. The ASL 220 can transport water from the interface with the AFL 215 at the top side of the ASL 220 to the interface with the AFL 215 at the bottom side of the ASL 220. The ASL 220 can allow the flow of hydrogen into the AFL 215. Ionized oxygen entering the ASL 220 can react with carbon monoxide to generate carbon dioxide and conduction electrons. The ASL 220 can be electrically conductive and can be connected to an electrical contact that can be configured to allow the flow of electrons 251 from the ASL 220 to an external electrical load 255.

The AFL 215 can be deposited on the top side of the ASL 220, and can be composed of the same material as the ASL 220. The AFL 215 can be impregnated with SDC or other oxygen-transporting electrolyte.

The AFL 215 can have finer pores compared to the ASL 220, providing greater surface area (compared to the ASL) to promote the ionization of hydrogen. The AFL 215 can also promote the oxidation of ionized hydrogen to form water. The AFL 215 can have an enlarged triple phase (pore phase, electron-conducting phase, and ion-conducting phase) boundary (TPB).

Example SOFCs having the three layer anode structure depicted in FIG. 2 were fabricated using certain technologies described above. The depictions of the ARL 225, ASL 220, and AFL 215 in FIG. 2 include cross-sectional images of each anode layer of a fabricated example SOFC. The images of the anode layers shown in FIG. 2 were generated using a scanning electron microscope (SEM). The SEM images of the anode layers shown in FIG. 2 are for illustrative purposes, and no attempt was made to scale the image for a given layer in relation to an image of any other layer.

The ASL 220 and AFL 215 layers of some of the example SOFCs are composed of Ni-BZCYYb with the AFL 215 being a fine functional Ni-ZYCYYB layer having enlarged TPB. After deposition of the AFL 215 on the ASL 220 but before deposition of the ARL 225, SDC is infused into the ASL 220 and AFL 215 layers through the bottom side of the ASL 220. The ARL 225 layer of some of the example SOFCs is composed of ceria nanorods 275; however, as will be appreciated and understood, alternative structures such as nanocubes, and alternative materials could be used in the ARL. The ARL 225 of some of the example SOFCs is ceria doped with Ni and Ru, resulting in at least some of the Ni and Ru residing as singly dispersed ions on the surface of the ceria nanorods.

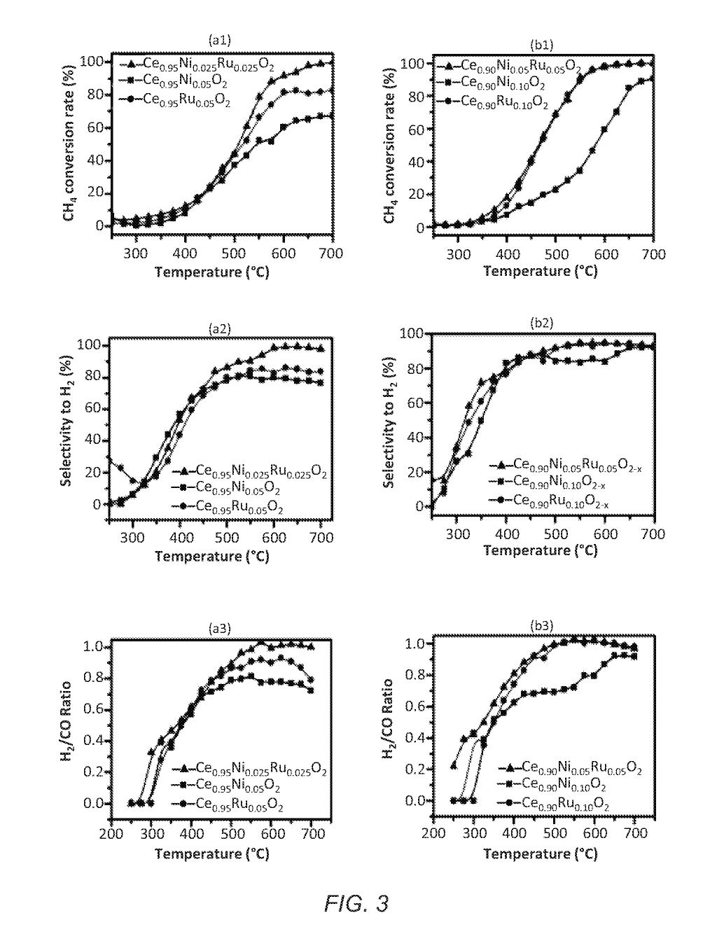

For the purposes of example and without limiting the scope of the disclosure, the effectiveness of ceria powder doped with various ratios of Ni and Ru at reforming carbon was tested with results provided in TABLE 1 and FIGS. 3(a1), 3(b1), 3(a2), 3(b2), 3(a3), and 3(b3). Tests were performed with a dry reforming gas ratio of 1CH₄:1CO₂.

TABLE 1

| Catalysts | Ea of CH₄ (kJ/mol) | Ea of CO₂ (kJ/mol) |
|---|---|---|
| Ce_{0.95}Ni_{0.025}Ru_{0.025}O₂ | 44.69 | 41.66 |
| Ce_{0.95}Ru_{0.05}O₂ | 52.86 | 48.53 |
| Ce_{0.95}Ni_{0.05}O₂ | 62.79 | 60.28 |
| Ce_{0.90}Ni_{0.05}Ru_{0.05}O₂ | 40.56 | 40.26 |
| Ce_{0.90}Ru_{0.10}O₂ | 46.49 | 45.73 |
| Ce_{0.90}Ni_{0.10}O₂ | 52.72 | 50.94 |

Results suggest that small amounts (less than 10%) of Ru or Ni dopants to CeO₂ can dramatically increase the occurrence of reforming reactions 295 in the ARL 225; and the combination of Ru and Ni can increase the occurrence of reforming reactions 295 in the ARL 225 compared to the corresponding amount of a single dopant. For the example fabricated SOFCs tested, results suggest an ARL 225 composed of 5% Ru, 5% Ni, and 90% Ce by weight can optimize reforming activity in the ARL 225 at intermediate temperatures. Similar tests were performed with a steam reforming gas ratio of 2CH₄:3H₂O. Results from steam reforming tests also suggest the combination of Ru and Ni can increase the occurrence of reforming reactions 295 in the ARL 225.

Electrolyte Technologies

Referring to FIG. 2, an electrolyte layer 210 can be deposited on the top side of the anode layers. The bottom side of the electrolyte layer can interface with the top side of the AFL 215. The electrolyte layer can be a dense ceramic layer that can be a single ceramic material or a composite ceramic. The electrolyte layer can be a composed of an oxide ion conductor, a proton conductor, or a composite of an oxide ion conductor and a proton conductor.

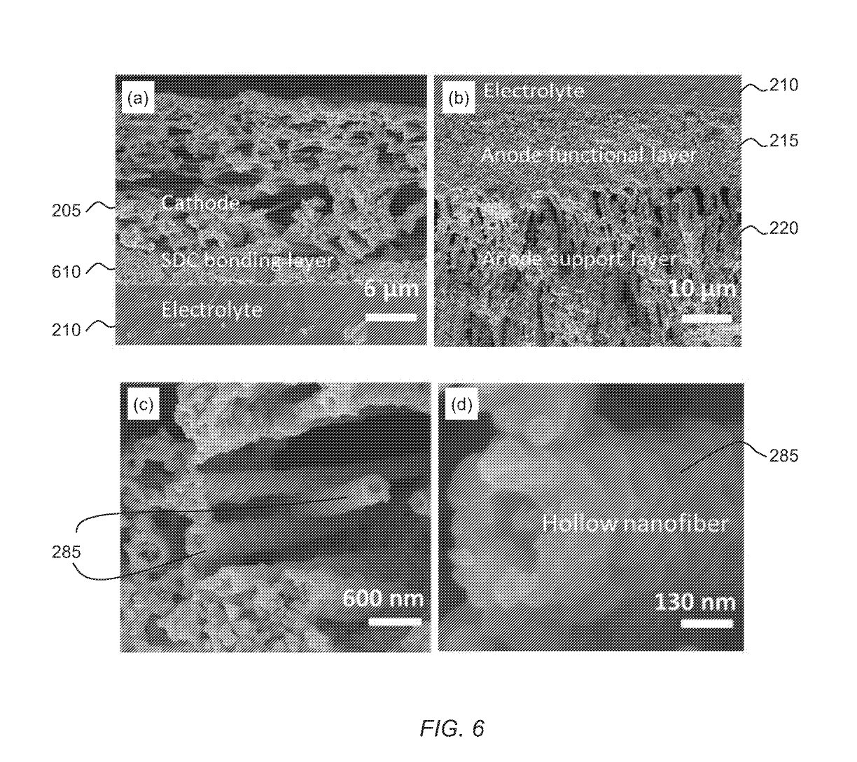

FIG. 6(b) shows an example fabricated SOFC having a dense electrolyte layer 210 on an AFL 215 having a fine pore structure on an ASL 220 having a coarse pore structure according to an example embodiment.

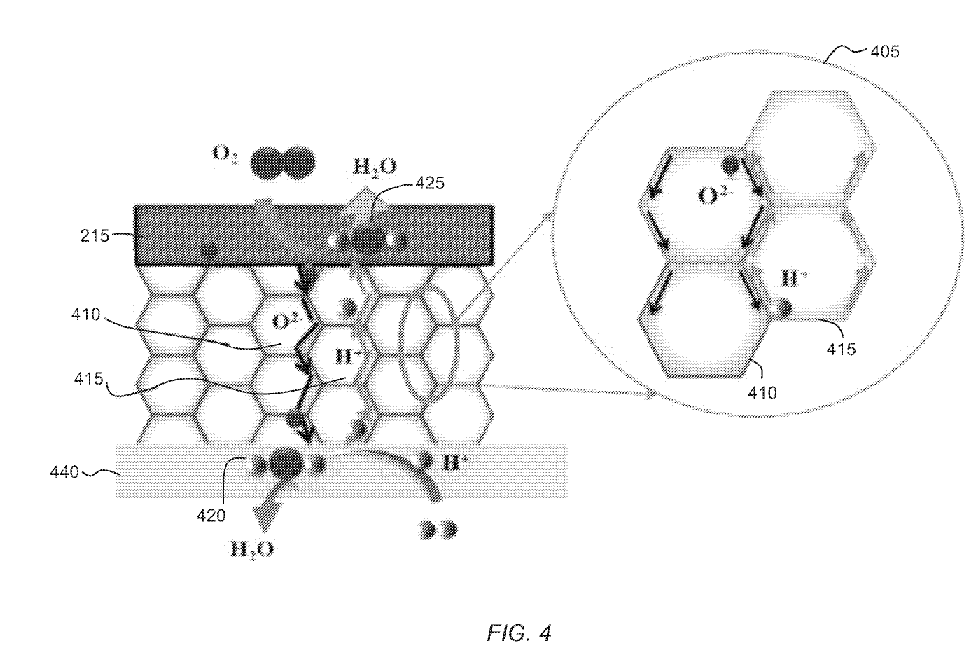

Returning to FIG. 4, it shows a conceptual drawing illustrating ion transport in a mixed-ion conducting membrane electrolyte structure including an oxide ion conductor and a proton conductor according to an example embodiment. As illustrated in FIG. 4, the electrolyte can be composed of alternating layers of oxide ion conductor 410 and proton conductor 415 electrolyte material. A magnified conceptual drawing 405 in FIG. 4 illustrates the direction of travel of oxygen ions and protons. As shown, the cathode layer 205 can serve to ionize oxygen for transport through the oxide ion conductor 410 to the anode 440, where the oxygen ions can react with hydrogen to form water 420. At the same time, hydrogen can be ionized in the anode layer 440, transported through the proton conductor 415 and react with oxygen to form water 425. The electrolyte layer can be a composite of SDC and barium yttrium zirconate BaZr_{0.85}Y_{0.15}O_{3-δ} (BZY15), a proton-transporting electrolyte composite having vertical grain boundaries.

Utilization of an electrolyte containing an oxide ion conductor 410 allows oxygen to be transported from a cathode layer to an anode layer in an SOFC. The oxygen in the anode is necessary for reforming reactions in order to reduce or prevent carbon deposition in the anode when utilizing a direct hydrocarbon fuel source.

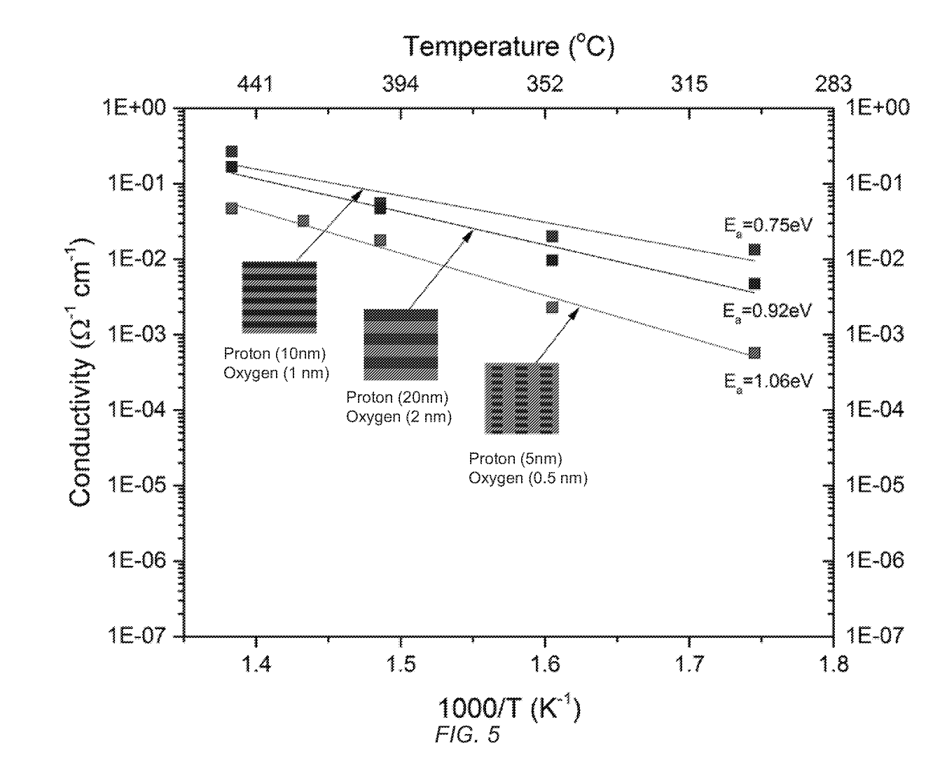

The interfaces between oxide ion conductor 410 and proton conductor 415 in the electrolyte can be tailored to achieve optimal SOFC performance. FIG. 5 provides data indicating ion conductivity as a function of temperature for mixed-ion conducting membrane electrolyte structures having various heterostructures according to an example embodiment. Of the heterostructures tested, those having alternating 10 nm proton conductor 415 layers and 1 nm oxygen ion conductor 410 layers showed the best performance (highest ion conductivity). Heterostructures with 5 nm proton conductor layers/0.5 nm oxygen ion conductor layers and heterostructures with 20 nm proton conductor layers/2 nm oxygen ion conductor layers were also tested resulting in data shown in FIG. 5.

Cathode Technologies

Referring back to FIG. 2, a cathode layer 205 can be deposited on a top side of an electrolyte layer 210. The cathode layer 205 in FIG. 2 is depicted with a magnified image showing a nanofiber structure. A magnified conceptual illustration 280 depicts a nanofiber 285 with nanoparticles 290 attached to the surface of the nanofiber 285.

FIGS. 6(a), 6(b), 6(c), and 6(d) show cross-sectional images of an example fabricated SOFC showing certain layers of the SOFC structure at increasing magnification according to an example embodiment. According to an example embodiment, the cathode layer 205 can be separated from the electrolyte layer 210 by a SDC bonding layer 610. The SDC bonding layer can serve to prevent the cathode and electrolyte layer from reacting and forming an insulating layer. Although the example embodiments depict the SDC bonding layer 610 as composed of SDC, other suitable materials can be used.

FIGS. 6(c) and 6(d) show magnified images of hollow nanofiber structures 285 in the cathode layer 205 of an example fabricated SOFC. The nanofibers 285 can be composed of PrBa_{0.5}Sr_{0.5}Co_{1.5}Fe_{0.5}O_{5+δ} (PBSF) or other suitable material (such as La_{0.6}Sr_{0.4}Co_{0.2}Fe_{0.8}O₃, PrBa_{0.5}Sr_{0.5}CO₂O₆, Sm_{0.5}Sr_{0.5}CoO₃, etc.) infiltrated with nano-PrOₓ or other oxygen reducing catalyst (such as SDC, GDC, Pr_{0.1}Ce_{0.9}O₂, Pr₂Ni_{0.5}Mn_{0.5}O₄, etc.).

For the purpose of example and without limiting the scope of the disclosure, hollow nanofibers of PrBa_{0.5}Sr_{0.5}Co₂O_{5+δ} (PBSC), created by an electrospinning process, are assembled into a three dimensional (3D) fibrous porous electrode, providing facile pathways for gas transport and excellent electrical conductivity for efficient charge transfer and, thus greatly enhancing the rate of oxygen reduction reactions (ORR), as confirmed by electrical testing that demonstrates the small electrode polarization resistance and low activation energy of fabricated example hollow nanofiber cathodes.

Example hollow nanofiber cathodes were manufactured by first electrospinning a PBSC precursor solution then calcining in air at 950° C. for two hours with a ramping rate of 2° C./min resulting in hollow PBSC fibers composed of nanosized grains of PBSC, the grains having diameters of approximately 20 to 100 nm. Second, the PBSC nanofiber mat was flooded with a polyvinyl butyral (PVB)/ethanol solution (a common binder/solvent for commercial tape-casting) then dried at 25° C. for two hours, removing the ethanol, resulting in a strong and flexible fiber mat. Third, coupons were punched from the nanofiber mat and bonded to the top of a GDC electrolyte membrane using a SDC slurry and co-fired at 950° C. for two hours. Referring back to FIG. 6(c) and FIG. 6(d), the resulting hollow nanofibers 285 in the example hollow nanofiber cathodes had an inner diameter of approximately 100 nm and an outer diameter of approximately 300 nm and lengths substantially longer than the outer diameter.

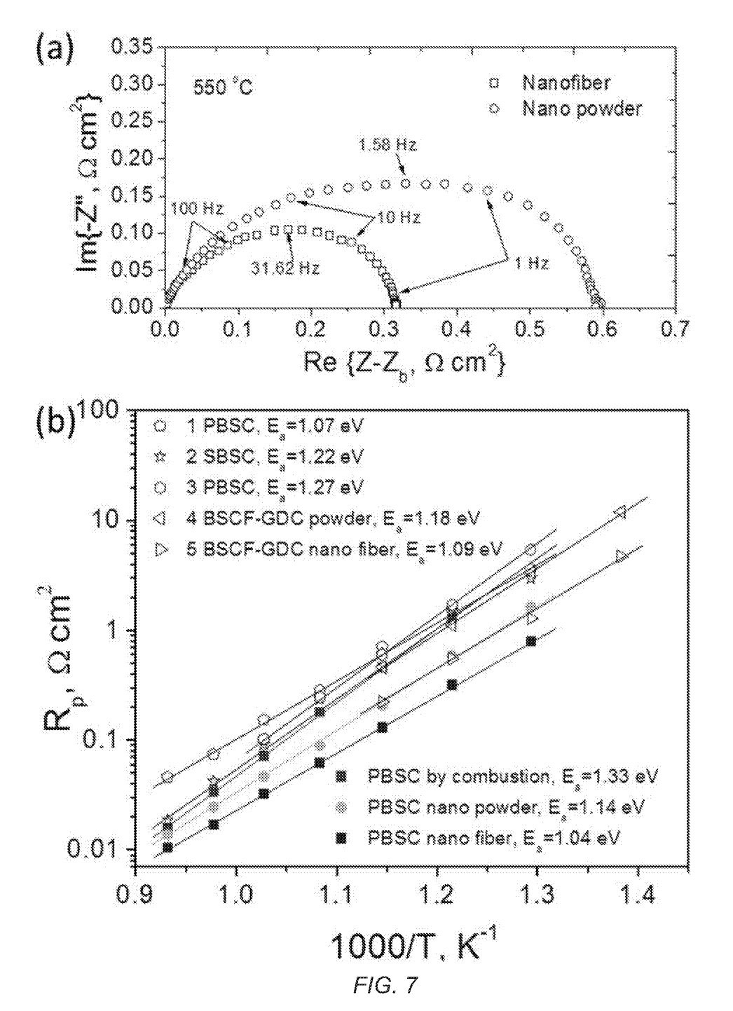

FIG. 7(a) and FIG. 7(b) show electrical testing data from the fabricated example hollow nanofiber cathodes. For comparison, a paste of PBSC nanopowder composed of crushed PBSC fibers and a binder (V006) was also prepared and painted on SDC pellets. FIG. 7(a) shows typical impedance spectra of cathodes based on PBSC hollow nanofiber (square) and nanopowder (crushed fiber) (circle) measured at 550° C. under open circuit conditions. FIG. 7(b) shows a comparison of polarization resistance (Rₚ) and apparent activation energy (Ea) for PBSC hollow nanofiber (black solid square), PBSC nanopowder (light grey circle), PBSC prepared by combustion (grey square), PBSC derivatives or fibers cathode reported by others: 1 PBSC [J. H. Kim, M. Cassidy, J. T. S. Irvine, J. Bae, J. Electrochem. Soc. 156 (2009) B682B689] (pentagon), 2 SBSC [i.d.], 3 PBSC [H. Ding, X. Xue, Electrochim. Acta 55 (2010) 3812-3816] (star), 4 BSCF-GDC powder [J. G. Lee, J. H. Park, Y. G. Shul, Nat. Commun. 5 (2014)] (left pointing triangle), and BSCF-GDC core-shell fiber [i.d.] (right pointing triangle). Example fabricated hollow nanofiber cathodes show much lower area specific resistance compared to cathodes based on nanopowder.

SOFC Manufacturing Process

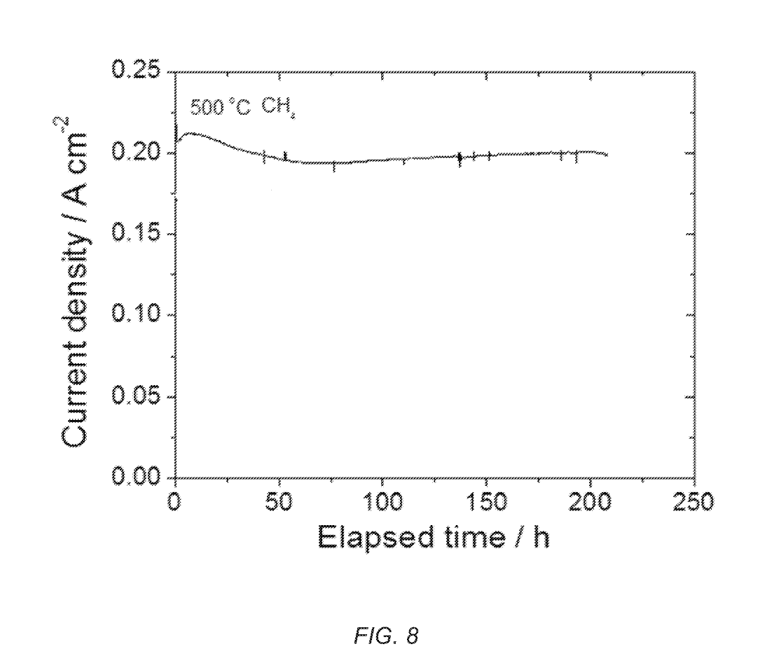

Example SOFCs were manufactured using the following steps resulting in a functional SOFC capable of utilizing a direct hydrocarbon fuel source at a temperature of 500° C. at 0.7 V on 97% methane and 3% water. Functional SOFCs resulting from the described process demonstrate the proof of concept with 200 hours of operation of the functional SOFCs as presented in FIG. 8. Functional SOFCs representative of the data presented in FIG. 8 have a layered structure similar to that illustrated in FIG. 2. The described functional SOFCs developed through the described manufacturing process are not intended to limit possible structures that can utilize technologies described in this disclosure.

1. Create anode support layer (ASL). Functional SOFCs presented herein are manufactured through typecasing; however other known processes could be utilized. The ASL of functional SOFCs is composed of highly porous Ni-BZCYYb, although other suitable materials could be utilized.

2. Create anode functional layer (AFL). The AFL is created by refined slurry coating process; however other processes could be utilized. The AFL of functional SOFCs are composed of Ni-BZCYYb, however other suitable materials could be utilized. The AFL has finer pores compared to the ASL, providing greater surface area compared to the ASL, and promoting ionization of hydrogen.

During SOFC development, the combination of an ASL and an AFL composed of Ni-BZCYYb together with an electrolyte composed of SDC was shown to result in a better performing direct-hydrocarbon, intermediate temperature SOFC. It is hypothesized that Ni-BZCYYb and SDC at the interface between the AFL and electrolyte layer form an electron blocking layer, thereby reducing unwanted electron leakage current through the electrolyte layer.

3. Create an electrolyte layer. The electrolyte layer of function SOFCs is created by refined slurry coating process; however other processes could be utilized. Various functional SOFCs having differing electrolyte structures containing SDC and BZY15 were manufactured. The composite could be made of an oxygen transporter other than SDC, and a proton transporter other than BZY15. Data presented in FIG. 8 illustrates results from a functional SOFC having an electrolyte composed of SDC without a proton transporter.

4. Co-fire the stack presented that includes the ASL, AFL, and electrolyte. Functional SOFCs representative of the data presented in FIG. 8 are co-fired at 1400° C. for five hours.

5. Create an SDC bonding layer at the electrolyte interface. The SDC layer is created by refined slurry coating. The resulting SDC bonding layer in functional SOFCs is between approximately 3 to 4 μm thick.

6. Create a cathode layer at the SDC bonding layer interface. The cathode layer in a functional SOFC representative of the data presented in FIG. 8 is painted on the SDC bonding layer. The cathode layer is composed of electrospun hollow oxide PBSCF nanofibers (300 nm) mixed with PrOₓ nanoparticles by solution infiltration, where the mass ratio of fiber and PrOₓ is approximately 1:1. Other suitable materials could be utilized to form hollow nanofibers with nanoparticle catalysts, and other ratios of fiber to nanoparticle could be utilized.

7. Co-fire the stack including the ASL, AFL, electrolyte, SDC bonding layer, and cathode. Functional SOFCs representative of the data presented in FIG. 8 are co-fired at between 1050° C. and 1080° C. for two hours.

8. Impregnate ASL with SDC. The SDC serves to promote catalysts and can be effecting at promoting methane reforming, conversion of CO into CO₂ (water-gas shift), and ionization of hydrogen. Other suitable materials can also be utilized in place or in addition to SDC. Through the impregnation process, SDC can also impregnate the AFL. SDC impregnation can also be performed following the co-firing of the ASL, AFL, and electrolyte layer, i.e. at some point after step 4, but before step 9.

9. Create anode reforming layer (ARL). The ARL of functional SOFCs representative of the data presented in FIG. 8 are created by slurry coating. The ARL comprises ceria nanorods with Ru and Ni dopants. The Ru and Ni dopants exist as both dispersed ions on the surface of the ceria nanorods and as nanoparticles.

10. Co-fire completed stack comprising ARL, ASL, AFL, electrolyte, SDC bonding layer, and cathode layer. Functional SOFCs representative of the data presented in FIG. 8 are co-fired at 800° C. for two hours.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

1. A fuel cell comprising:
an anode comprising a doped ceria catalyst;
an electrolyte comprising:
an oxygen ion transporting solid oxide fuel cell (SOFC) electrolyte material; and
a proton transporting SOFC electrolyte material; and
a cathode;
wherein the ratio of oxygen ion transporting SOFC electrolyte material to proton transporting SOFC electrolyte material is approximately 1:10; and
wherein the fuel cell is configured to directly utilize hydrocarbon fuel at temperatures of 500° C. or less.

2. The fuel cell of claim 1, wherein the anode comprises:
an anode functional layer (AFL);
an anode support layer (ASL); and
anode reforming layer (ARL).

3. The fuel cell of claim 2, wherein the AFL and ASL layers comprise Ni-based material.

4. The fuel cell of claim 2, wherein the AFL and ASL layers comprise Ni—BaZr_{0.1}Ce_{0.7}Y_{0.1}Yb_{0.1}O_{3-δ}.

5. The fuel cell of claim 2, wherein the ARL layer comprises the doped ceria catalyst.

6. The fuel cell of claim 2, wherein the ASL layer is impregnated with sameria-doped ceria (SDC).

7. The fuel cell of claim 2, wherein the AFL and ASL layers have a pore structure; and
wherein the AFL layer has a finer pore structure than the ASL layer.

8. The fuel cell of claim 5, wherein the doped ceria catalyst comprises Ni and Ru doped ceria.

9. The fuel cell of claim 5, wherein the doped ceria catalyst comprises Ni and Ru supported ceria.

10. The fuel cell of claim 5, wherein the doped ceria catalyst comprises Ni and Ru doped ceria and Ni and Ru supported ceria.

11. The fuel cell of claim 5, wherein at least a portion of the dopants are ions dispersed on a surface of the ceria.

12. The fuel cell of claim 5, wherein the doped ceria comprises nanofibers.

13. The fuel cell of claim 8, wherein the sum of Ni and Ru by weight is approximately 10% or less.

14. The fuel cell of claim 8, wherein Ni is present at approximately 5% by weight of the ARL.

15. The fuel cell of claim 8, wherein Ru is present at approximately 5% by weight of the ARL.

16. The fuel cell of claim 8, wherein the doped ceria includes an oxygen vacancy near one of the Ni or Ru dopants dispersed as ions on the surface of the ceria.

17.-18. (canceled)

19. The fuel cell of claim 1, wherein the oxygen ion transporting SOFC electrolyte material comprises sameria-doped ceria; and
wherein the proton transporting SOFC electrolyte material comprises barium yttrium zirconate.

20. (canceled)

21. The fuel cell of claim 1, wherein the electrolyte comprises alternating layers of the oxygen ion transporting SOFC electrolyte material and the proton transporting SOFC electrolyte material.

22. The fuel cell of claim 21, wherein grain boundaries between the oxygen ion transporting SOFC electrolyte material and the proton transporting SOFC electrolyte material are substantially vertical.

23. The fuel cell of claim 1, wherein the cathode comprises hollow oxide nanofibers.

24. The fuel cell of claim 23, wherein the nanofibers have an average outer diameter between 200 nm and 400 nm and an average inner diameter between 50 nm and 150 nm.

25. The fuel cell of claim 23, wherein the nanofibers comprise one or more materials selected from the group consisting of PrBa_{0.5}Sr_{0.5}Co_{1.5}Fe_{0.5}O_{5+δ}, La_{0.6}Sr_{0.4}Co_{0.2}Fe_{0.8}O₃, PrBa_{0.5}Sr_{0.5}Co₂O₆, and Sm_{0.5}Sr_{0.5}CoO₃.

26. The fuel cell of claim 23 further comprising nanoparticles residing on an outer surface of the hollow oxide nanofibers.

27. The fuel cell of claim 26, wherein the nanoparticles comprise one or more materials selected from the group consisting of PrOₓ, sameria-doped ceria (SDC), gadolinia-doped ceria (GDC), and Pr_{0.1}Ce_{0.9}O₂, Pr₂Ni_{0.5}Mn_{0.5}O₄.

28. A fuel cell comprising:
an anode comprising a doped ceria catalyst;
an electrolyte; and
a cathode;
wherein the fuel cell is configured to directly utilize hydrocarbon fuel while operating with a current density of at least 200 mA/cm² and an open circuit voltage of 0.75 V at temperatures of 500° C. or less for two hours or more without deactivation.

29. The fuel cell of claim 1, wherein the fuel cell is configured to directly utilize hydrocarbon fuel and yield a peak power density of 0.368 W/cm² at temperatures of 500° C. or less.

30.-33. (canceled)

34. The fuel cell of claim 28, wherein the fuel cell is configured to directly utilize hydrocarbon fuel and yield a peak power density of 0.368 W/cm² at temperatures of 500° C. or less.

35. The fuel cell of claim 1, wherein the doped ceria catalyst is active for wet and dry reforming of methane.

36.-60. (canceled)

61. The fuel cell of claim 1, wherein the cathode is formed by the process of:
electrospinning an oxide material;
calcining the electrospun oxide material, resulting in a mat of hollow oxide nanofibers;
flooding the mat of hollow oxide nanofibers with a mixture containing a binder and a solvent;
drying the mat of hollow oxide nanofibers; and
bonding the mat of hollow oxide nanofibers to an electrolyte layer.

62. The fuel cell of claim 2, wherein the cathode comprises a cathode layer, the fuel cell formed by a process comprising:
forming the anode support layer (ASL);
forming the anode functional layer (AFL) on a top of the ASL;
forming an electrode layer on a top of the AFL layer;
co-firing the ASL, AFL, and electrode layers;
forming the cathode layer on a top of the electrode layer;
co-firing the ASL, AFL, electrode, and cathode layers;
forming the anode reforming layer (ARL) on a bottom of the ASL; and
co-firing the ASL, AFL, electrode, cathode, and ARL layers.

63. The process of claim 62 further comprising contacting a buffer layer material with a top of the electrode layer.

64. The process of claim 62 further comprising impregnating the ASL layer with Sm_{0.52}CeO_{1.9}.
